(19) United States
(12) Patent Application Publication
(10) Pub. No.: US 2026/0297997 A1
(43) Pub. Date: Oct. 1, 2026

(54) LOCKING MECHANISM FOR A CASKET LID

(71) Applicant: Batesville Services, LLC, Batesville, IN (US)

(72) Inventor: Gregory William Wray, Guilford, IN (US)

(73) Assignee: Batesville Services, LLC, Batesville, IN (US)

(21) Appl. No.: 19/577,912

(22) Filed: Mar. 25, 2026

Related U.S. Application Data
(60) Provisional application No. 63/779,425, filed on Mar. 28, 2025.

(51) Int. Cl. E05C 19/10; A61G 17/02

(52) U.S. Cl. CPC E05C 19/10; A61G 17/02

(57) ABSTRACT

A locking mechanism for a casket to maintain a lid of the casket in a closed position. The locking mechanism includes a body latch and a lid latch. The body latch includes a body mounting wall, an upper wall extending from the body mounting wall in a first direction, and an engagement portion extending from the body mounting wall in a second direction opposite the first direction. A channel is defined between the body mounting wall and the engagement portion. The lid latch includes a lid mounting wall, and a hook extending from the lid mounting wall. The hook is insertable into the channel of the body latch and engageable with the engagement portion to inhibit removal of the lid latch from the body latch.

### CROSS-REFERENCE TO RELATED APPLICATION

This application claims the benefit of co-pending U.S. Provisional Patent Application No. 63/779,425, filed Mar. 28, 2025, for “Locking Mechanism For A Casket Lid,” which is hereby incorporated by reference in its entirety including the drawings.

### TECHNICAL FIELD

The present specification generally relates to caskets and, more specifically, locking mechanisms for securing a lid to a body of the casket.

### BACKGROUND

Traditionally, caskets are designed with lids that are securely fastened to the body of the casket to ensure structural integrity and prevent unintended opening. Various locking mechanisms have been developed for this purpose, ranging from simple latch systems to more complex mechanical or electromechanical locks. Many conventional locking mechanisms rely on threaded fasteners, cam locks, or compression seals to maintain closure. However, these designs often require tools for operation, can be time-consuming to engage or disengage, and may not provide an optimal balance between security, ease of use, and reliability. Additionally, environmental factors such as moisture and temperature fluctuations can impact the durability and performance of certain locking systems, leading to potential failures over time.

Accordingly, a need exists for improved locking mechanisms for casket lids that enhances the security, ease of operation, and durability of casket closures.

### SUMMARY

In one embodiment, a locking mechanism includes: a body latch including: a body mounting wall; an upper wall extending from the body mounting wall in a first direction; and an engagement portion extending from the body mounting wall in a second direction opposite the first direction, a channel defined between the body mounting wall and the engagement portion; and a lid latch including: a lid mounting wall; and a hook extending from the lid mounting wall, the hook insertable into the channel of the body latch and engageable with the engagement portion to inhibit removal of the lid latch from the body latch.

In another embodiment, a casket includes: a body including a first side wall, a second side wall opposite the first side wall, a first end wall, and a second end wall opposite the first end wall; a lid rotatable coupled to the second side wall and positionable relative to the body between an open position and a closed position; and a locking mechanism including: a body latch mounted to the body; and a lid latch mounted to the lid, wherein engagement of the lid latch with the body latch when the lid is in the closed position inhibits movement of the lid toward the open position.

In yet another embodiment, a method includes: mounting a body latch of a locking mechanism to an inner surface of a first side wall of a body of a casket, the body latch including: a body mounting wall; an upper wall extending from the body mounting wall in a first direction; and an engagement portion extending from the body mounting wall in a second direction opposite the first direction, a channel defined between the body mounting wall and the engagement portion; mounting a lid latch of the locking mechanism to a lower surface of a lid of the casket, the lid latch including: a lid mounting wall; and a hook extending from the lid mounting wall, the hook insertable into the channel of the body latch and engageable with the engagement portion to inhibit removal of the lid latch from the body latch.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a partial side view of a casket including a lid being secured to a body of the casket by a locking mechanism, according to one or more embodiments shown and described herein;

FIG. 2 schematically depicts a front perspective view of a body latch of the locking mechanism, according to one or more embodiments shown and described herein;

FIG. 3 schematically depicts a rear perspective view of the body latch of the locking mechanism, according to one or more embodiments shown and described herein;

FIG. 4 schematically depicts a rear perspective view of a lid latch of the locking mechanism, according to one or more embodiments shown and described herein;

FIG. 5 schematically depicts a front perspective view of the lid latch of the locking mechanism, according to one or more embodiments shown and described herein;

FIG. 6 schematically depicts the locking mechanism in an unlocked position, according to one or more embodiments shown and described herein; and

FIG. 7 schematically depicts the locking mechanism in a locked position, according to one or more embodiments shown and described herein.

### DETAILED DESCRIPTION

Embodiments described herein are directed to a locking mechanism for a lid of a casket that secures the lid to a body of the casket and permits the unlocking of the lid without the use of any tools.

The locking mechanism includes a body latch and a lid latch that is engageable with the body latch to inhibit removal of the lid latch from the body latch. Various embodiments of the locking mechanism and the operation of the locking mechanism are described in more detail herein. Whenever possible, the same reference numerals will be used throughout the drawings to refer to the same or like parts.

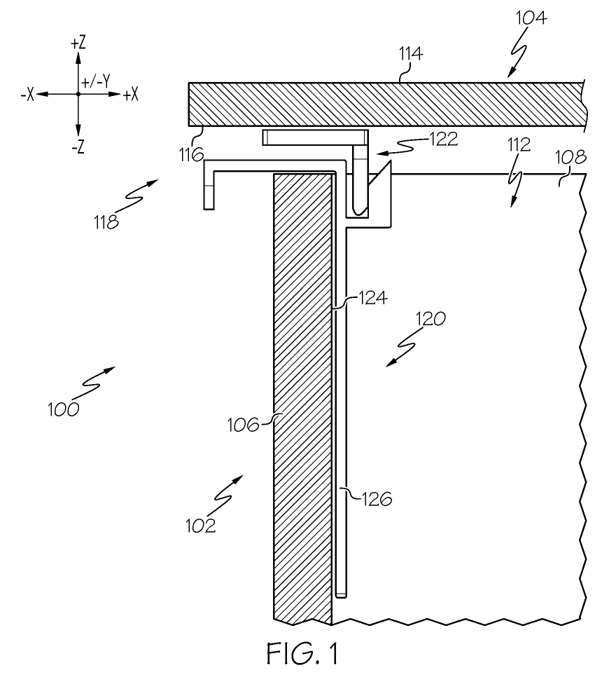

As used herein, the term “longitudinal direction” refers to the forward-rearward direction (i.e., in the +/- Y direction of the coordinate axes depicted in FIG. 1). The term “lateral direction” refers to the cross direction (i.e., in the +/- X direction of the coordinate axes depicted in FIG. 1), and is transverse to the vehicle longitudinal direction. The term “vertical direction” refers to the upward-downward direction (i.e., in the +/- Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings. Directional terms as used herein - for example up, down, right, left, front, back, top, bottom - are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Referring now to FIG. 1, a partial view of a casket 100 is illustrated according to one or more embodiments described herein. The casket 100 includes a body 102 and a lid 104 rotatably coupled to the body 102. The body 102 includes a pair of side walls 106 (only one shown), a pair of end walls 108 (only one shown) extending between the pair of side walls 106, and a bottom wall (not shown) cooperating to define an open interior 112. The lid 104 includes an upper surface 114 and a lower surface 116 opposite the upper surface 114 that faces the open interior 112 when in a closed position relative to the body 102 of the casket 100.

As shown, the casket 100 includes a locking mechanism 118 mounted to the body 102 and the lid 104. The locking mechanism 118 includes a body latch 120 and a lid latch 122 separate from and engageable with the body latch 120. In embodiments, the body latch 120 is mounted to the body 102, and the lid latch 122 is mounted to the lid 104. More particularly, in embodiments, the body latch 120 is mounted to an inner surface 124 of one of the side walls 106, and the lid latch 122 is mounted to the lower surface 116 of the lid 104. However, it should be appreciated that the body latch 120 may be mounted to any suitable surface of the body 102 such as, for example, one of the end walls 108 of the body 102. Similarly, the lid latch 122 may be mounted to any suitable surface of the lid 104, such as an edge of the lid 104. Additionally, it should be appreciated that in other embodiments, the body latch 120 may be mounted to the lid 104 and the lid latch 122 may be mounted to the body 102 without departing from the scope of the present disclosure.

As described in more detail herein, the lid latch 122 engages the body latch 120 as the lid 104 is lowered or rotated toward the body 102 into the closed position. With the lid latch 122 engaged with the body latch 120, the locking mechanism 118 is in a locked position. Additionally, upon operating the body latch 120, as described in more detail herein, the body latch 120 may partially deform to permit the lid latch 122 to disengage the body latch 120 and allow the lid 104 to be raised or rotated away from the body 102 and into an open position. With the lid latch 122 spaced apart from and disengaged with the body latch 120, the locking mechanism 118 is in an unlocked position.

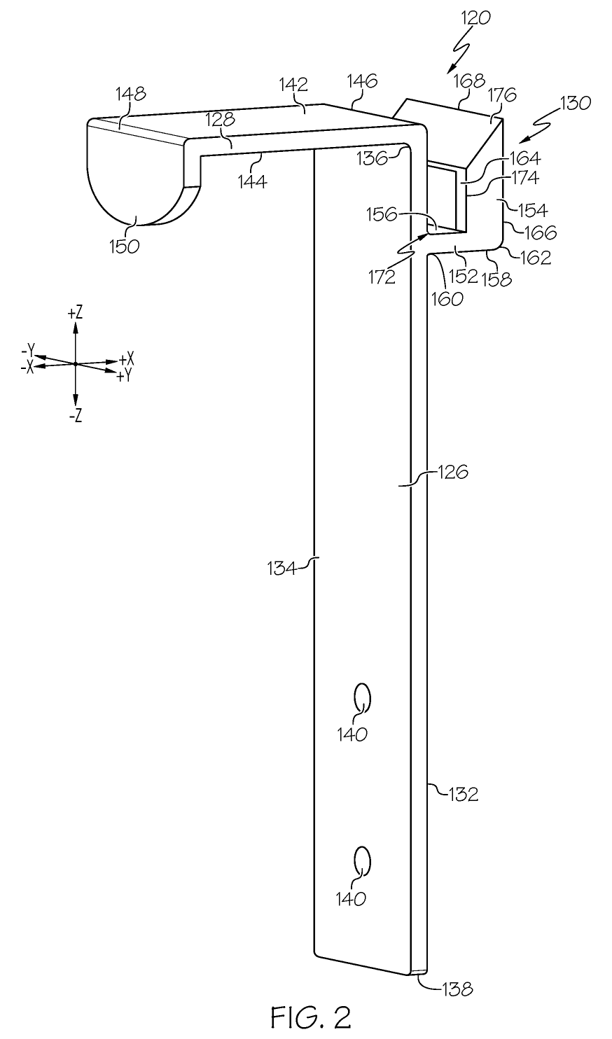

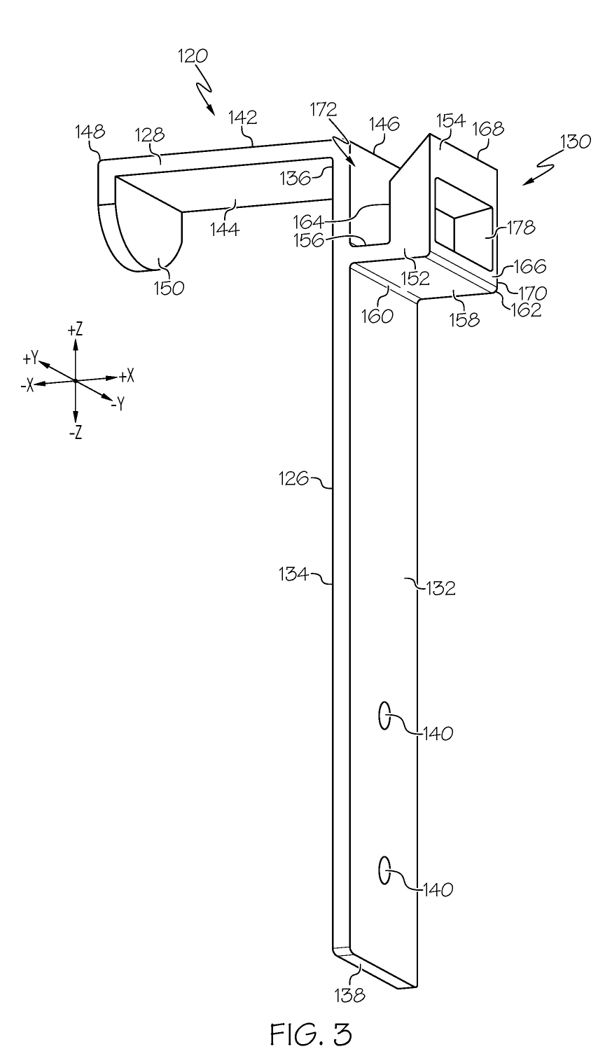

Referring now to FIGS. 2 and 3, the body latch 120 is shown separate from the other components of the casket 100. The body latch 120 includes a body mounting wall 126, an upper wall 128, and an engagement portion 130. The body mounting wall 126 includes an inner surface 132, an outer surface 134 opposite the inner surface 132, an upper end 136, and a lower end 138 opposite the upper end 136. In embodiments, one or more holes 140 are formed in the body mounting wall 126 extending through the inner surface 132 and the outer surface 134. As shown, a plurality of holes 140 are formed in the body mounting wall 126 in a linear direction (+/-Z axis) between the lower end 138 and the upper end 136 of the body mounting wall 126. However, the holes 140 may be arranged in any suitable location. The holes 140 permit a fastener to extend thereto and fix the body mounting wall 126 of the body latch 120 to the inner surface 124 of a side wall 106 of the body 102 of the casket 100 (FIG. 1). However, it should be appreciated that any number of holes 140 may be formed in the body mounting wall 126. Additionally, the body latch 120 may be mounted to the body 102 of the casket 100 in any suitable manner other that fasteners extending through the holes 140 and described herein.

The upper wall 128 includes an upper surface 142, a lower surface 144 opposite the upper surface 142, a first end 146, and a second end 148 opposite the first end 146. As shown, the first end 146 of the upper wall 128 extends from the upper end 136 of the body mounting wall 126 in a direction opposite the inner surface 132 of the body mounting wall 126. However, in other embodiments, the upper wall 128 may extend from any portion of the outer surface 134 of the body mounting wall 126 between the upper end 136 and the lower end 138 of the body mounting wall 126.

In embodiments, a tab 150 is provided at the second end 148 of the upper wall 128 opposite the body mounting wall 126. As shown, the tab 150 extends in a direction opposite the upper surface 142 of the upper wall 128. In embodiments, the tab 150 has a semicircular shape. However, the tab 150 may have any suitable shape such as square, rectangular, triangular, or the like.

Referring still to FIGS. 2 and 3, the engagement portion 130 extends from the inner surface 132 of the body mounting wall 126. The engagement portion 130 includes a body extension wall 152 and a receiving wall 154. The body extension wall 152 includes an upper surface 156, a lower surface 158 opposite the upper surface 156, a first end 160, and a second end 162 opposite the first end 160. The first end 160 of the body extension wall 152 extends from the inner surface 132 of the body mounting wall 126 in a direction opposite the outer surface 134 of the body mounting wall 126. As shown, the body extension wall 152 extends from the body mounting wall 126 at a location closer to the upper end 136 of the body mounting wall 126 than to the lower end 138 of the body mounting wall 126. However, it should be appreciated that the body extension wall 152 may extend from the inner surface 132 of the body mounting wall 126 at any suitable location other than that depicted herein.

The receiving wall 154 includes an inner surface 164, an outer surface 166 opposite the inner surface 164, an upper end 168, and a lower end 170 opposite the upper end 168. The lower end 170 of the receiving wall 154 of the engagement portion 130 extends from the second end 162 of the body extension wall 152 in a direction opposite the lower surface 158 of the body extension wall 152. Accordingly, a channel 172 is provided between the outer surface 166 of the receiving wall 154 and the inner surface 132 of the body mounting wall 126.

In embodiments, the outer surface 166 of the receiving wall 154 includes a planar portion 174 extending from the body extension wall 152 and a sloped portion 176 extending between the planar portion 174 and the upper end 168 of the receiving wall 154. Specifically, in embodiments, the sloped portion 176 is oriented such that a width of the receiving wall 154 extending between the inner surface 164 and the outer surface 166 decreases in the +Z direction from the planar portion 174 to the upper end 168. The sloped portion 176 is oriented at an angle relative to a vertical plane extending parallel to the planar portion 174. In embodiments, the angle is 45 degrees +/- 20 degrees. In embodiments, the angle is 45 degrees +/- 10 degrees. In embodiments, the angle is 45 degrees +/- 5 degrees. In embodiments, a window 178 is formed in the receiving wall 154 extending through the inner surface 164 and the outer surface 166 of the receiving wall 154. In embodiments, the window 178 is formed within the receiving wall 154 below the sloped portion 176 of the receiving wall 154. With the body extension wall 152 extending from the body mounting wall 126 closer to the upper end 136 of the body mounting wall 126 than the lower end 138 of the body mounting wall 126, the window 178 formed in the receiving wall 154 overlaps the channel 172 formed between the body mounting wall 126 and the receiving wall 154 in the XZ plane.

In other embodiments, the window 178 may not be provided. Instead, a lip, not shown, may extend from the outer surface 166 of the receiving wall 154 in a direction toward the body mounting wall 126. Just as the window 178 may be formed to receive a portion of the lid latch 122 to secure the lid latch 122 to the body latch 120, as described in more detail herein, the lip, if provided, may permit engagement with a portion of the lid latch 122.

In embodiments, the body latch 120 is formed as a one-piece, monolithic component. In other embodiments, the body mounting wall 126, the upper wall 128, and/or the engagement portion 130 are fixed to one another as separate components. The body latch 120 may be formed from any suitable material that provides a limited amount of deformation, such as silicone, rubber, thermoplastic polyurethane, polyethylene foam, neoprene, thermoplastic elastomer, polyvinyl chloride, and the like.

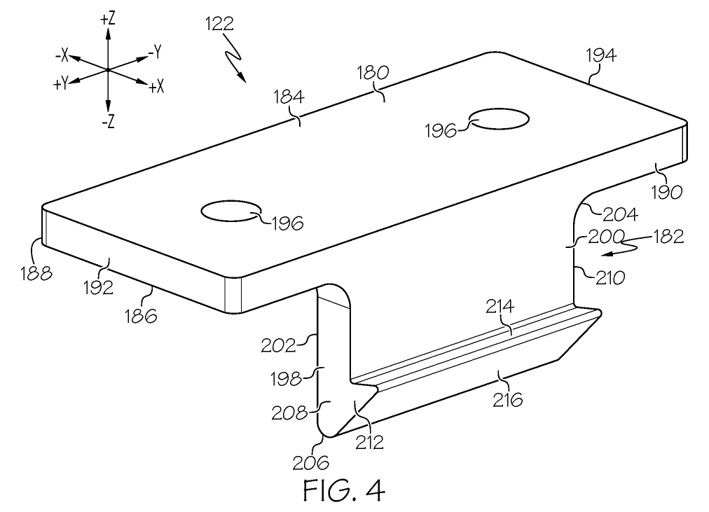

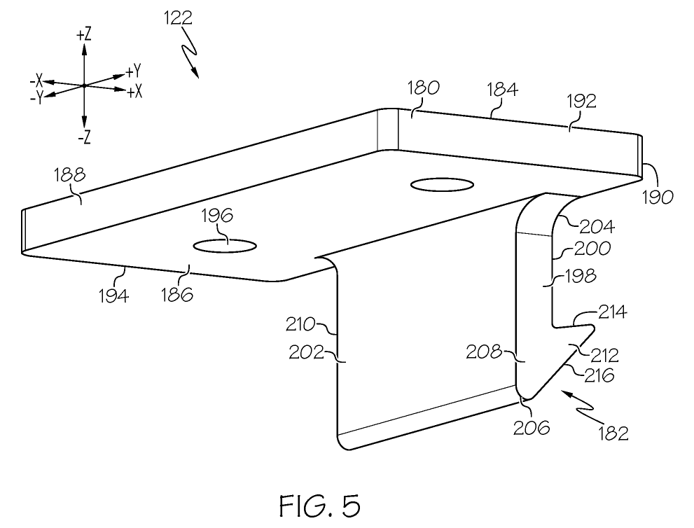

Referring now to FIGS. 4 and 5, the lid latch 122 is shown separate from the other components of the casket 100. The lid latch 122 includes a lid mounting wall 180 and a hook 182 extending from the lid mounting wall 180. The lid mounting wall 180 includes an upper surface 184, a lower surface 186 opposite the upper surface 184, an inner edge 188, and an outer edge 190 opposite the inner edge 188. Additionally, the lid mounting wall 180 includes a first side edge 192 and a second side edge 194 opposite the first side edge 192. A distance between the first side edge 192 and the second side edge 194 defines a width of the lid mounting wall 180 extending in the +/-Y axis. In embodiments, one or more holes 196 are formed in the lid mounting wall 180 extending through the upper surface 184 and the lower surface 186. As shown, a plurality of holes 196 are formed in the lid mounting wall 180 extending in a linear direction between the first side edge 192 and the second side edge 194. However, the holes 196 may be arranged in any suitable location. The holes 196 permit a fastener to extend thereto and fix the lid mounting wall 180 of the lid latch 122 to the lower surface 116 of the lid 104 of the casket 100 (FIG. 1). However, it should be appreciated that any number of holes 196 may be formed in the lid mounting wall 180. Additionally, the lid latch 122 may be mounted to the lid 104 of the casket 100 in any suitable manner other that fasteners extending through the holes 196 and described herein.

The hook 182 includes a lid extension wall 198 having an inner surface 200, an outer surface 202 opposite the inner surface 200, an upper end 204, and a lower end 206 opposite the upper end 204. The upper end 204 of the lid extension wall 198 extends from the lower surface 186 of the lid mounting wall 180 proximate the inner edge 188 of the lid mounting wall 180. However, it should be appreciated that the lid extension wall 198 may extend from any suitable location of the lid mounting wall 180 such as the inner edge 188 or the outer edge 190 of the lid mounting wall 180, and may be located closer to the outer edge 190 than to the inner edge 188. Additionally, the lid extension wall 198 includes a first side edge 208 and a second side edge 210 opposite the first side edge 208. A distance between the first side edge 208 and the second side edge 210 defines a width of the lid extension wall 198 extending in the +/-Y axis. In embodiments, the width of the lid extension wall 198 is less than the width of the lid mounting wall 180. Additionally, in embodiments, the lid extension wall 198 is centered along the lower surface 186 and the inner edge 188 of the lid mounting wall 180 between the first side edge 192 and the second side edge 194 of the lid mounting wall 180. In other embodiments, the lid extension wall 198 is positioned closer to the first side edge 192 of the lid mounting wall 180 than to the second side edge 194 of the lid mounting wall 180. In other embodiments, the lid extension wall 198 is positioned closer to the second side edge 194 of the lid mounting wall 180 than to the first side edge 192 of the lid mounting wall 180. In other embodiments, the width of the lid extension wall 198 is equal to the width of the lid mounting wall 180. In other embodiments, the width of the lid extension wall 198 is greater than the width of the lid mounting wall 180.

The hook 182 includes a lip 212 extending from the inner surface 200 and the lower end 206 of the lid extension wall 198 in a direction opposite the outer surface 202 of the lid extension wall 198. The lip 212 defines a shoulder 214 extending from the inner surface 200 of the lid extension wall 198 between the lower end 206 and the upper end 204 of the lid extension wall 198. In embodiments, the lip 212 includes a sloped portion 216 extending from the lower end 206 of the lid extension wall 198 to the shoulder 214 of the lip 212. Specifically, in embodiments, the sloped portion 216 is oriented such that a width of the lip 212 extending from the inner surface 200 of the lid extension wall 198 in the +/-X axis decreases in the -Z direction from the shoulder 214 to the lower end 206 of the lid extension wall 198. The sloped portion 216 is oriented at an angle relative to a horizontal plane extending parallel to the shoulder 214. In embodiments, the angle is 45 degrees +/- 20 degrees. In embodiments, the angle is 45 degrees +/- 10 degrees. In embodiments, the angle is 45 degrees +/- 5 degrees. As described in more detail herein, an angular orientation of the sloped portion 216 of the lip 212 corresponds to an angular orientation of the sloped portion 176 of the receiving wall 154 of the body latch 120 (FIG. 2).

In embodiments, the lid latch 122 is formed as a one-piece, monolithic component. In other embodiments, the lid mounting wall 180, the lid extension wall 198, and/or the lip 212 are fixed to one another as separate components. The lid latch 122 may be formed from any suitable material that provides a limited amount of deformation, such as silicone, rubber, thermoplastic polyurethane, polyethylene foam, neoprene, thermoplastic elastomer, polyvinyl chloride, and the like. In other embodiments, the lid latch 122 is formed from a rigid material that does not deform during normal operation.

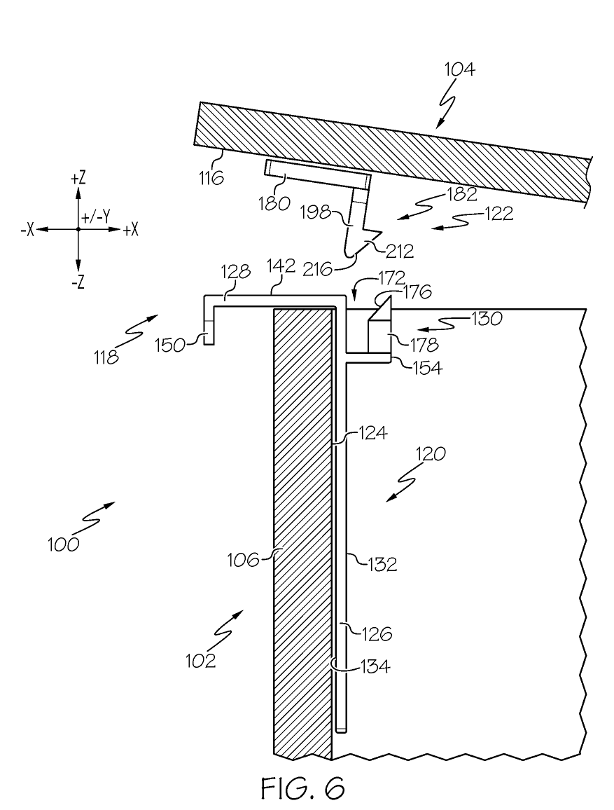

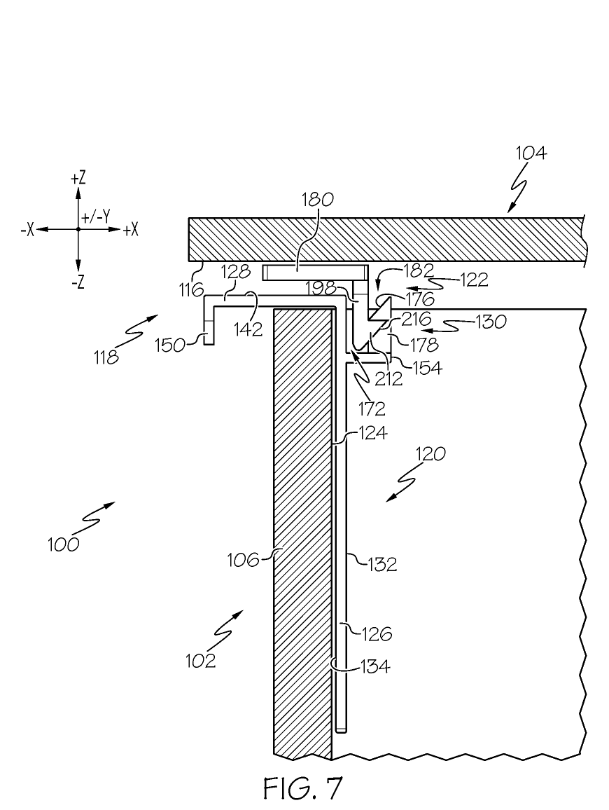

Referring now to FIGS. 6 and 7, the locking mechanism 118 is shown in the unlocked position (FIG. 6) and the locked position (FIG. 7). As shown in FIG. 6, the lid 104 of the casket 100 is rotated away from the body 102 of the casket 100 such that the lid latch 122, which is mounted to the lower surface 116 of the lid 104, is spaced apart from the body latch 120, which is mounted to the inner surface 124 of one of the side walls 106 of the body 102.

Upon the lid 104 rotating from the open position toward body 102 and into the closed position, the sloped portion 216 of the lip 212 of the lid latch 122 contacts the sloped portion 176 of the receiving wall 154 of the body latch 120. Pressure from the hook 182 against the receiving wall 154 causes one or both the hook 182 and the receiving wall 154 to deform. Specifically, in embodiments in which the hook 182 is formed from a resilient material, the hook 182 bows in a direction toward the lid mounting wall 180 of the lid latch 122. In embodiments in which the receiving wall 154 is formed from a resilient material, the receiving wall 154 bows in a direction opposite the upper wall 128 of the body latch 120.

Accordingly, as shown in FIG. 7, the hook 182 is permitted to enter the channel 172 formed between the receiving wall 154 and the lid mounting wall 180. Additionally, once the hook 182 is fully positioned within the channel 172, the hook 182 returns to an original, unbowed position such that the lip 212 is permitted to enter the window 178 formed in the receiving wall 154 of the body latch 120. With the locking mechanism 118 in the locked position, the shoulder 214 of the lip 212 engages the receiving wall 154 such that the lid 104 of the casket 100 is inhibited from being rotated toward the open position.

The locking mechanism 118 may be moved from the locked position to the unlocked position by a user applying manual pressure against the upper surface 142 of the upper wall 128 of the body latch 120 proximate the tab 150. As shown, the thickness of the side wall 106 of the body 102 of the casket 100 has a width extending in the +/-X axis less than a width of the upper wall 128 of the body latch 120. Thus, upper wall 128 of the body latch 120 defines an overlap proximate the tab 150. Specifically, force applied against the upper surface 142 of the upper wall 128 of the body latch 120 proximate the tab 150 causes the receiving wall 154 of the body latch 120 to bow away from the body mounting wall 126 of the body latch 120 and permit the lip 212 to be moved out of the window 178 formed in the receiving wall 154. Thus, the lid 104 of the casket 100 may be moved from the closed position toward the open position. Thereafter, when pressure is no longer applied against the upper wall 128 of the body latch 120, the receiving wall 154 returns to an original, unbowed position.

From the above, it is to be appreciated that defined herein is a locking mechanism for a casket that inhibits movement of a lid of the casket into an open position from a closed position relative to a body of the casket. The locking mechanism includes a body latch and a lid latch that is engageable with the body latch to inhibit removal of the lid latch from the body latch. The lid latch includes a hook that engages a receiving wall of the body latch to permit engagement of the lid latch with the body latch. The lid latch may be disengaged by applying a force onto an upper wall of the body latch, which results in the receiving wall of the body latch bowing in a direction away from the hook of the lid latch, thereby permitting the lid latch to be moved away from the body latch.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A locking mechanism comprising:
a body latch comprising:
a body mounting wall;
an upper wall extending from the body mounting wall in a first direction; and
an engagement portion extending from the body mounting wall in a second direction opposite the first direction, a channel defined between the body mounting wall and the engagement portion; and
a lid latch comprising:
a lid mounting wall; and
a hook extending from the lid mounting wall, the hook insertable into the channel of the body latch and engageable with the engagement portion to inhibit removal of the lid latch from the body latch.

2. The locking mechanism of claim 1, wherein the engagement portion bows in a direction away from the body mounting wall upon a force being applied against an upper surface of the upper wall.

3. The locking mechanism of claim 1, wherein the engagement portion comprises:
a body extension wall extending from the body mounting wall; and
a receiving wall extending from the body extension wall.

4. The locking mechanism of claim 3, wherein a window is formed in the receiving wall.

5. The locking mechanism of claim 4, wherein the receiving wall includes an inner surface defining a planar portion extending from the body extension wall and a sloped portion extending from the planar portion to an upper end of the receiving wall.

6. The locking mechanism of claim 5, wherein the hook comprises:
a lid extension wall extending from the lid mounting wall; and
a lip extending from the lid extension wall.

7. The locking mechanism of claim 6, wherein the lip of the hook is received within the window formed in the receiving wall to inhibit removal of the lid latch from the body latch.

8. The locking mechanism of claim 6, wherein the lip includes a sloped portion oriented at an angle corresponding to the sloped portion of the receiving wall of the engagement portion of the body latch.

9. The locking mechanism of claim 6, wherein:
the lid mounting wall has a first width extending between a first side edge and a second side edge opposite the first side edge; and
the lid extension wall has a second width extending between a first side edge and a second side edge opposite the first side edge, the second width being less than the first width.

10. The locking mechanism of claim 1, wherein:
one or more holes are formed in the body mounting wall; and
one or more holes are formed in the lid mounting wall.

11. A casket comprising:
a body including a first side wall, a second side wall opposite the first side wall, a first end wall, and a second end wall opposite the first end wall;
a lid rotatable coupled to the second side wall and positionable relative to the body between an open position and a closed position; and
a locking mechanism comprising:
a body latch mounted to the body; and
a lid latch mounted to the lid,
wherein engagement of the lid latch with the body latch when the lid is in the closed position inhibits movement of the lid toward the open position.

12. The casket of claim 11, wherein:
the body latch is mounted to an inner surface of the first side wall; and
the lid latch is mounted to a lower surface of the lid.

13. The casket of claim 11, wherein:
the body latch comprises:
a body mounting wall;
an upper wall extending from the body mounting wall in a first direction; and
an engagement portion extending from the body mounting wall in a second direction opposite the first direction, a channel defined between the body mounting wall and the engagement portion; and
the lid latch comprises:
a lid mounting wall; and
a hook extending from the lid mounting wall, the hook insertable into the channel of the body latch and engageable with the engagement portion to inhibit removal of the lid latch from the body latch.

14. The casket of claim 13, wherein the engagement portion bows in a direction away from the body mounting wall upon a force being applied against an upper surface of the upper wall.

15. The casket of claim 13, wherein:
the engagement portion comprises:
a body extension wall extending from the body mounting wall; and
a receiving wall extending from the body extension wall, a window is formed in the receiving wall;
the hook comprises:
a lid extension wall extending from the lid mounting wall; and
a lip extending from the lid extension wall, the lip of the hook is received within the window formed in the receiving wall to inhibit removal of the lid latch from the body latch.

16. The casket of claim 15, wherein:
the receiving wall includes an inner surface defining a planar portion extending from the body extension wall and a sloped portion extending from the planar portion to an upper end of the receiving wall; and
the lip includes a sloped portion oriented at an angle corresponding to the sloped portion of the receiving wall of the engagement portion of the body latch.

17. The casket of claim 15, wherein:
the lid mounting wall has a first width extending between a first side edge and a second side edge opposite the first side edge; and
the lid extension wall has a second width extending between a first side edge and a second side edge opposite the first side edge, the second width being less than the first width.

18. A method comprising:
mounting a body latch of a locking mechanism to an inner surface of a first side wall of a body of a casket, the body latch comprising:
a body mounting wall;
an upper wall extending from the body mounting wall in a first direction; and
an engagement portion extending from the body mounting wall in a second direction opposite the first direction, a channel defined between the body mounting wall and the engagement portion; and
mounting a lid latch of the locking mechanism to a lower surface of a lid of the casket, the lid latch comprising:
a lid mounting wall; and
a hook extending from the lid mounting wall, the hook insertable into the channel of the body latch and engageable with the engagement portion to inhibit removal of the lid latch from the body latch when the lid of the casket is in a closed position.

19. The method of claim 18, further comprising:
rotating the lid into the closed position from an open position;
positioning the hook into the channel to engage the engagement portion; and
inhibiting rotating the lid from the closed position to the open position.

20. The method of claim 18, further comprising applying a force against an upper surface of the upper wall of the body latch to bow the engagement portion in a direction away from the body mounting wall.
